(19) United States
(12) Patent Application Publication
(10) Pub. No.: US 2018/0349754 A1
(43) Pub. Date: Dec. 6, 2018

(54) COMMUNICATION REPLY BOT

(71) Applicant: Microsoft Technology Licensing, LLC, Redmond, WA (US)

(72) Inventors: Michael J. Kumar, Seattle, WA (US); Shahil Soni, Seattle, WA (US)

(21) Appl. No.: 15/612,777

(22) Filed: Jun. 2, 2017

(51) Int. Cl. G06N 3/00; G06F 17/30; G06N 5/02; G06F 17/27

(52) U.S. Cl. CPC G06N 3/006; G06F 17/2705; G06N 5/02; G06F 17/30867

(57) ABSTRACT

A method includes accessing, via a response bot, an electronic communication addressed to a user, wherein the electronic communication includes a request, identifying via the response bot, at least one of communications or documents to search based on the request, obtaining search results from the identified communications or documents matching the request, generating a response to the request based on the search results, generating a confidence level for the response, and automatically sending the response to a sender of the electronic communication, the response including the confidence level for the response.

### BACKGROUND

When users deal with a queue of emails or other communications that they do not currently have time to respond to, the senders of such emails may not receive responses from the users in a timely manner. This can lead to frustration and reduced work efficiency while waiting for a response.

### SUMMARY

A method includes accessing, via a response bot, an electronic communication addressed to a user wherein the electronic communication includes a request, identifying via the response bot, at least one of communications and documents to search based on the request, obtaining search results from the identified communications or documents matching the request, and automatically sending a response to the request, the response including a calculated confidence level for the response.

A device including a processor and a memory device coupled to the processor and having a program stored thereon for execution by the processor to cause the processor to perform operations. The operations include accessing, via a response bot, an electronic communication addressed to a user wherein the electronic communication includes a request, identifying, via the response bot, at least one of communications or documents to search based on the request, obtaining search results from the identified communications or documents matching the request, and automatically sending a response to the request, the response including a calculated confidence level for the response.

A machine readable storage device having instructions for execution by a processor of a machine to cause the processor to perform operations. The operations accessing, via a response bot, an electronic communication addressed to a user wherein the electronic communication includes a request, identifying, via the response bot, at least one of communications or documents to search based on the electronic communication request, obtaining search results from the identified communications or documents matching the request, and automatically sending a response to the request, the response including a calculated confidence level for the response.

### BRIEF DESCRIPTION OF THE DRAWINGS

FIG. 1 is a block diagram illustrating an example environment for facilitating communications between a first device that generates requests to a second device according to an example embodiment.

FIG. 2 is a block flow diagram illustrating a system that utilizes a response bot to respond to communication requests according to an example embodiment.

FIG. 3 is a high level flowchart illustrating a method of automatically responding to a request generated by a recipient's response bot according to an example embodiment.

FIG. 4 is a flowchart illustrating a method of automatically responding to a request generated by a recipient's response bot according to an example embodiment.

FIG. 5 is a block diagram illustrating an example response bot according to an example embodiment.

FIG. 6 is a block schematic diagram of a computer system to implement a response bot that generates automated responses to requests in communications according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations, Unless explicitly stated otherwise, structures (e.g., structural components, such as modules) are optional and may be combined or subdivided, and operations (e.g., in a procedure, algorithm, or other function) may vary in sequence or be combined or subdivided.

Example methods (e.g., algorithms) and systems (e.g., special-purpose machines detect a communication from a requester that contains a request for information, search other communications and/or documents responsive to the request, generate a response to the request, as well as a confidence level of the response, and send the response with an indication that the response is automatically generated. The confidence level in the response may also be included with the response.

In some embodiments, bots may be to used perform such methods. The bots may implement natural language processing (NLP) and/or artificial intelligence (AI). In an example, a bot operates as an app or application that users interact with in a conversational way. Bots can communicate conversationally with text, cards, speech, images, and other means. A bot may be as simple as basic pattern matching with a response, or it may be a sophisticated agent weaving NLP with AI techniques. The bot may use one or more channels to receive communications. A channel to an email program may be used to receive emails from requestors, and other channels may be utilized to connect to other communication mechanisms, such as messaging mechanisms or video conferencing mechanisms.

In further embodiments, hots using artificial intelligence such as neural networks and NLP, may be generated using bot frameworks, such as Microsoft Bot Framework, and may be trained on the communications and documents that are searched to generate the response. Such training allows the generation of an automated response that may begin to appear to be drafted by the user receiving the communication. The response may take the form of text, voice, images, or video for example.

A bot connector service may be used to connect a bot to one or more channels and handle the message exchange between them. This connecting service allows the bot to communicate over many channels without manually designing a specific message for each channel's schema.

A connector may use an activity object to exchange information between bot and channel. Any communication going back and forth is an activity of some type. Some activities are invisible to the user, such as the notification that the bot has been added to a user's contact list.

One or more of the methodologies described herein facilitate automated generation of a response to a request, allowing a user to focus on high priority matters without having to constantly monitor and respond to communications such as email while ignoring higher priority matters, and while at the same time, appearing to provide a response that may help the requester receive a useful answer.

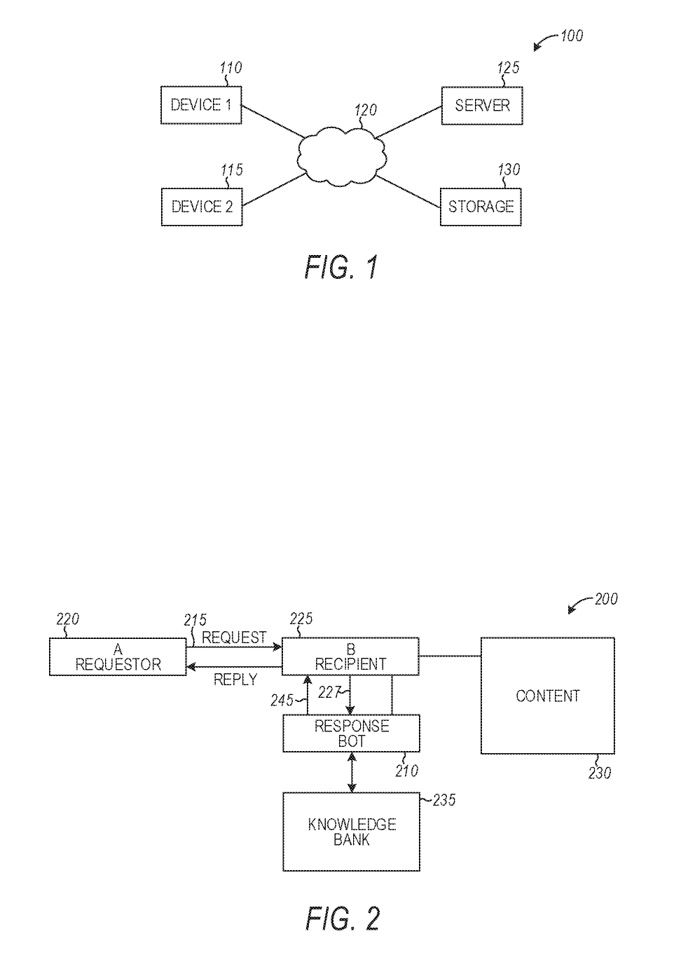

FIG. 1 is a block diagram illustrating an example environment 100 for facilitating communications between a first device 110 that generates requests to a second device 115 via a network 120. The devices may be coupled to the network via a wireless or wired connection. One or more servers 125 may also be coupled to network 120 to provide computing services for use by one or more of the network coupled devices. The servers 125 may also act as communication servers, such as email and message servers. The network itself may include cellular communication services between devices and external data sources 130.

One or more portions of the network 120 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, a satellite network, a cable network, a broadcast network, another type of network, or a combination of two or more such networks. Any one or more portions of the network 120 may communicate information via a transmission or signal medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

The user devices may comprise, but are not limited to, a smartphone, tablet, laptop, multi-processor system, microprocessor-based or programmable consumer electronics, game console, set-top box, or any other device that a user utilizes to communicate over the network 120. In example embodiments, the user devices 110, 115 may comprise a display module (not shown) to display information (e.g., in the form of user interfaces). In some embodiments, the user devices 110, 115 may comprise one or more of a touch screen, camera, keyboard, microphone, and Global Positioning System (GPS) device. The user devices 110, 115 may be a device of a user, which is used to receive, send, and display information (e.g., via user interfaces).

It is noted that the environment 100 shown in FIG. 1 is merely an example. For instance, any number and types of servers, storage, and devices may be coupled via network 120, which itself may consist of multiple public and private networks. Additionally, some components of the environment 100 may be combined. For example, some of the functions of the server 125 may be embodied within one or more user devices.

FIG. 2 is a block flow diagram illustrating a system 200 that utilizes a response bot 210 to respond to communication requests 215 from a requester 220 to a recipient 225. The requester 220 and recipient 225 may be various user devices as referenced above. Users, such as a requester, often send requests 215 that include questions or other requests via email, text, voicemail, and other electronic communication that may be handled by a quick response by a receiver or recipient of the request. The response bot 210 in one embodiment receives the requests as indicated at 227 and automatically acts on related documents and on related content 230 in the recipient's mailbox, either directly or through recipient 225 as indicated at 233, to automatically reply with a best guess answer to the requester. Other storage, local and remote, may be searched in further embodiments

Users often send questions over email where the answer is a simple fact. The response bot 210 may automatically reply on the recipient's behalf. The reply may indicate that the reply is an autoreply rather than a reply that is actually generated by the recipient. A knowledge bank 235, either stored locally or remote may contain information about the recipient, including previous responses, allowing the response bot to generate a response 240 that is responsive to the request. The response may be generated as a function of information in the knowledge bank 235 to mimic previous replies generated by the recipient such that a style of the response reflects a style of the recipient. The response is then sent to the requester at 245.

The knowledge bank 235 may contain information from parsed previous communications of the users. The parsed previous communications can provide the ability to understand interactions. Keywords may be used to determine the subject of the communication and to help determine where to search. For instance, a request generated by a parent looking for time, may lead to a search of a personal calendar for time versus a professional calendar. A request for time by a colleague may result in the professional calendar being searched, unless the subject is not business related and it is know that the users attend social events together.

In one example, User A (via requester 220) asks user B (via recipient 225) “When is the mail app's next release?” User B may or may not check mail for a few hours, and so User A will have to wait for a while to receive that quick answer directly from User B.

User B's response bot 210 may automatically reply with an answer immediately. User B's response bot may look through User B's mailbox and/or relevant documents in content 230 to find the answer, supplying a best guess answer, and indication that the response was automatically generated, and include a confidence score about the answer. One example response that may be sent by email, voicemail, text, or other visual or verbal communication may be sent to User A by User B's bot is: A: “B's bot has 85% confidence that the next mail app release is in March.” This response includes both an indication that the response is generated by a bot and a confidence level. This response further contains information responsive to the question asked in the request.

The response may be sent automatically, or with optional approval by recipient B. The approval option may be presented if information to be provided in the response may be personal information, confidential information, or other information which may be detected as potentially sensitive. Otherwise, the response may be sent automatically, such as without affirmative approval of recipient B.

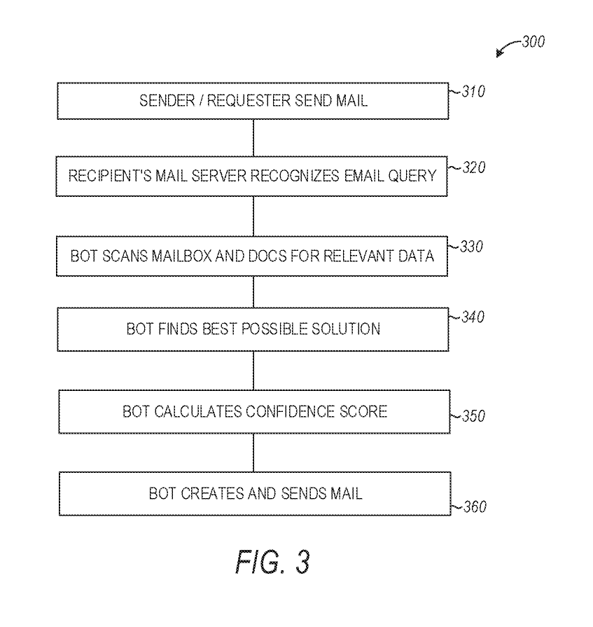

FIG. 3 is a flowchart illustrating a general method 300 of automatically responding to a request. The response may be generated by a recipient's response bot, which may be a self contained app or application, or may be integrated into an email program or service or elsewhere. At 310, a sender sends an email or other communication containing the request. The email is received by recipient's email server and by the response bot at 320. The response bot recognizes the email. At 330, the response bot scans a mailbox for relevant information, such as email and documents. Other storage, local and remote, may be searched in further embodiments. In one embodiment, search results may be obtained by the response bot from a search engine, which may be local or remote, such as a cloud based search engine, and operate over at least one of local and remotely stored content. In one embodiment, both email and documents may be scanned, and at least one of communications or documents may be found at 340. Note that at least one of communications and documents includes a single communication and/or a single document, as well as multiple communications and documents. The at least one of communications and documents comprises a best possible solution and contain information most responsive to the request. At 350, the response bot calculates a confidence score for the best possible solution, and at 360, the response bot creates and sends an email comprising the response. While method 300 has been described using email communications, any other method of communicating may be used in further embodiments, including messaging, voice calls, video calls, etc.

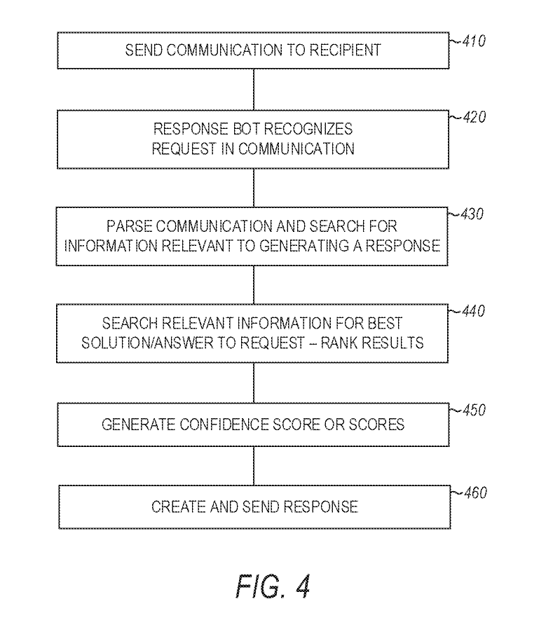

FIG. 4 is a flowchart illustrating a method 400 of automatically responding to a request generated by a recipient's response bot. At 410, a requester generates a communication and sends the communication to a recipient. The communication may comprise a request, such as a question for which the requester believes the recipient has an answer. At 420, a response bot recognizes the communication as containing a request or query. The recognition may be performed by observing a question mark in the communication, or via natural language processing to identify the communication as containing a question, such as a request for information. Words that are normally associated with a question or request for information may be included in a library and compared to the communication to determine that the communication contains such as request. The response bot may be part of an email server, or may be part of a user device, such as a phone, touchpad, laptop, desktop, or other communication device. The communication may be an email for purposes of this description of method 400, but may be another form of communication, for example a text, message, voice communication or other means, in further embodiments.

At 430, the response bot may parse the communication, applying natural language processing. The parsing provides information for the response bot to identify communications and documents to search based on the communication. The response bot may then scan content such as an email mailbox containing identified communications and containing documents for data relevant to generating a response to the request. The data to search may be selected based on the information in the communication. For example, if the communication contained a reference to a calendar or a meeting, calendar information may be selected for searching. Still further, if the requestor is a family member versus a colleague, either a personal calendar or a professional calendar may be searched. Prior communications between the requester and recipient may be searched. Filters, such as project code names or other keywords occurring in or labels applied in previous communications may also be used to select information to search for an answer.

The response bot uses the relevant data to find the best possible solutions to the question or query posed in the request at 440. The relevant data may be found via one or more search algorithms that may rank search results. Several such search algorithms are available, such as deployments provided by Microsoft Bing. In further embodiments, an artificial intelligence algorithm may be used to identify the most relevant information, along with a confidence score for the information.

At 450, the response bot calculates a confidence score for the best possible solutions. The confidence score may simply be a representation of where the solutions are in the ranked search results, or may be generated by AI used to match the results to the parsed request. The confidence level may be generated as a function of an AI algorithm analysis of the search results or by the AI matching a proposed response with the request, where the confidence level is then included in the proposed response. A higher confidence may be inferred where the request contains a document name that is found in the searched data.

At 460, the response bot creates and sends a response that may include the confidence score based on the best solution/answer used in generating the request. The response may be generated using past user generated responses to the same or similar questions as a template. The response bot may also update the knowledge bank with the response.

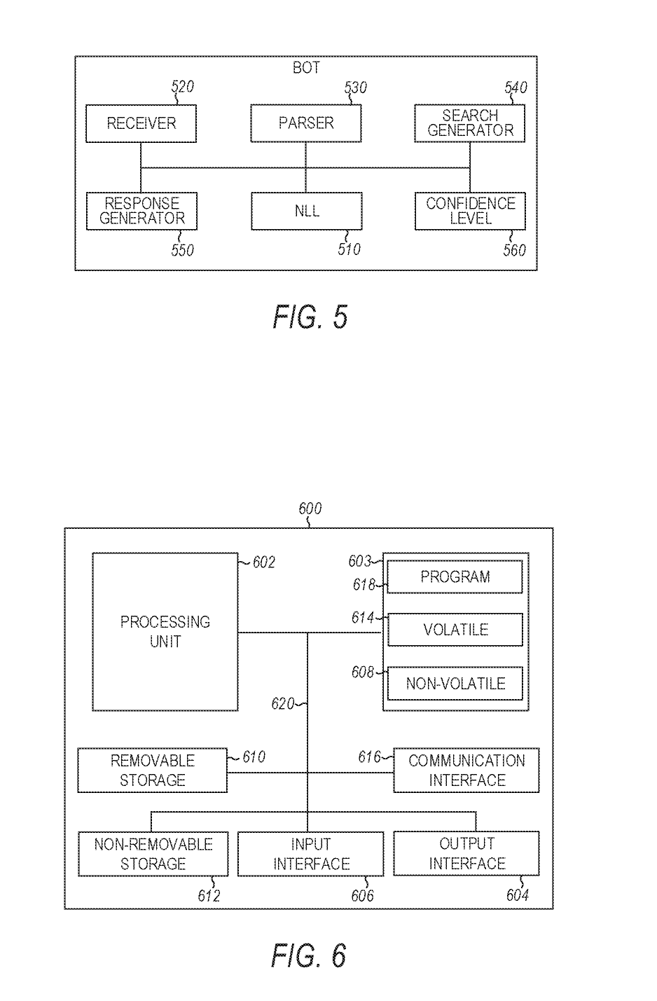

FIG. 5 is a block diagram illustrating an example response bot 500. To enable the parsing of received communications and generation of a response, response bot 500 may include a natural language library 510. The natural language library 510 comprises definitions and a repository of words or phrases typically found in communications, such as a communication relating to setting up a calendar event. For example, if a user indicates that a calendar event is dinner, the natural language library 510 may link “dinner” with “at” “with” and “on” since a user may want to include a location (e.g., “at”), a dining partner (e.g., “with”), and a date (e.g., “on”). Further, a time and date, the word “available”, and other words within the communication may be associated with a calendar related request. The suggestions (e.g., links) may change over time based on usage (e.g., what information do most people include for a particular topic or category). In some embodiments, the natural language library 510 may be located elsewhere and is accessible by the response bot 500. Note that in some embodiments, the communication may be in the form of a meeting request. The meeting request may have a known format that need not utilize NLP to determine how to generate a response.

Response bot 500 receives the request via a receiver 520, and parses the request via a parser 530. Using the parsed request and NLL 510, the content may be searched via a search generator 540, which may search the content, which includes calendar information, to determine Whether the user is available. A response may be generated via response generator 550 and sent, or queued for user approval to be sent. The response may indicate availability, may be a meeting request, or may even simple accept, decline, or propose an alternative time in an email or meeting request format. A confidence level in the response may also be generated via a confidence level generator 560, which may be as simple as using a ranking provided by search engine, which may be included in search generator 540.

In an example, that the confidence level may further be based on a precision of information matching search criteria. For instance, if a title of a document requested exactly matches a document found, the confidence level may be fairly high. Similarly, if more information about the document, such as an author, or even an exact physical address of the location of the document or indirect address matching the document is included in the request, the confidence level may be even higher. In some embodiments, a history of communications about the same document is included in content or knowledge base searched, the confidence level may be even higher.

The confidence score may be based on some combination of the retrieved information to be included in the response. In some embodiments, the confidence score is generated after the response is generated by combining one or more confidence scores of the information included in the response, such as by averaging such confidence scores or using a weighted average, or using a highest of lowest confidence score of the information included. Many other methods of generating a confidence score may be used in further embodiments, such as a search ranking information provided by a search engine used to provide the information included in the generated or to be generated response.

In one embodiment, the communication may be a voice or video call. The response bot may generate a response that may include a voice reading a verbal reply that the response bot generated. The voice may be generated to sound like the user, and even a visual representation of the user in the form of an avatar may appear in the response. The avatar may appear as images/video to look like the user.

In further embodiments, the response bot may prompt a user for approval in selected scenarios, to send a response that may contain sensitive information, or that may provide an estimate of a date or other data. Sensitive information may include a request for social security (SS) number or credit card (CC) number or information. The response bot may prompt the user for permission to send a response including such sensitive information.

FIG. 6 is a block schematic diagram of a computer system 600 to implement a response bot that generates automated responses to requests in communications, as well as other devices for performing methods and algorithms according to example embodiments. All components need not be used in various embodiments.

One example computing device in the form of a computer 600 may include a processing unit 602, memory 603, removable storage 610, and non-removable storage 612. Although the example computing device is illustrated and described as computer 600, the computing device may be in different forms in different embodiments. For example, the computing device may instead be a smartphone, a tablet, smartwatch, or other computing device including the same or similar elements as illustrated and described with regard to FIG. 6. Devices, such as smartphones, tablets, and smartwatches, are generally collectively referred to as mobile devices or user equipment. Further, although the various data storage elements are illustrated as part of the computer 600, the storage may also or alternatively include cloud-based storage accessible via a network, such as the Internet or server based storage.

Memory 603 may include volatile memory 614 and non-volatile memory 608. Computer 600 may include—or have access to a computing environment that includes—a variety of computer-readable media, such as volatile memory 614 and non-volatile memory 608, removable storage 610 and non-removable storage 612. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM). Digital Versatile Disks (DVD) or other optical disk storage, magnetic cassettes, magnetic tape, magnetic disk storage or other magnetic storage devices, or any other medium capable of storing computer-readable instructions.

Computer 600 may include or have access to a computing environment that includes input interface 606, output interface 604, and a communication interface 616. Output interface 604 may include a display device, such as a touchscreen, that also may serve as an input device. The input interface 606 may include one or more of a touchscreen, touchpad, mouse, keyboard, camera, one or more device-specific buttons, one or more sensors integrated within or coupled via wired or wireless data connections to the computer 600, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Bluetooth, or other networks. According to one embodiment, the various components of computer 600 are connected with a system bus 620.

Computer-readable instructions stored on a computer-readable medium are executable by the processing unit 602 of the computer 600, such as a program 618. The program 618 in some embodiments comprises software that, when executed by the processing unit 602, performs network switch operations according to any of the embodiments included herein. A hard drive, CD-ROM, and RAM are some examples of articles including a non-transitory computer-readable medium such as a storage device. The terms computer-readable medium and storage device do not include carrier waves to the extent carrier waves are deemed too transitory. Storage can also include networked storage, such as a storage area network (SAN). Computer program 618 may be used to cause processing unit 602 to perform one or more methods or algorithms described herein.

### EXAMPLES

1. A method comprising:

accessing, via a response bot, an electronic communication addressed to a user, wherein the electronic communication includes a request;
identifying via the response bot, at least one of communications and documents to search based on the request;
obtaining search results from the identified communications or documents matching the request; and
automatically sending a response to the request, the response including a calculated confidence level for the response.

2. The method of claim 1 wherein the response is generated by the response bot based on the search results.

3. The method of claim 2 wherein the response includes an indication that the response was generated by the response bot.

4. The method of any of examples 1-3 wherein the response is generated by the response bot as a function of a knowledge bank of previous communications.

5. The method of example 4 wherein the response bot updates the knowledge bank with the generated response.

6. The method of any of examples 1-5 wherein the confidence level is generated by the response bot.

7. The method of example 6 wherein the confidence level is generated as a function of an artificial intelligence algorithm analysis of the search results.

8. The method of any of examples 1-7 wherein identifying communications and documents to search comprises parsing the electronic communication using natural language processing to identify the request.

9. The method of example 8 wherein searching is performed via the response bot to obtain search results matching the request as a function of the parsed electronic communication.

10. A device comprising:

a processor; and
a memory device coupled to the processor and having a program stored thereon for execution by the processor to cause the processor to perform operations comprising:

accessing, via a response bot, an electronic communication addressed to a user, wherein the electronic communication includes a request;

identifying, via the response bot, at least one of communications or documents to search based on the request;

obtaining search results from the identified communications or documents matching the request; and

automatically sending a response to the request, the response including a calculated confidence level for the response.

11. The device of example 10 wherein the response is generated by the response bot based on the search results.

12. The device of any of examples 10-11 wherein the response includes an indication that the response was generated by the response bot.

13. The device of example 12 wherein the response is generated by the response as a function of a knowledge bank of previous communications and wherein the response bot updates the knowledge bank with the generated response.

14. The device of any of examples 12-13 wherein the confidence level is generated by the response bot.

15. The device of any of examples 12-14 wherein the confidence level is generated as a function of an artificial intelligence algorithm analysis of the search results.

16. The device of any of examples 12-15 wherein identifying communications and documents to search comprises parsing the electronic communication using natural language processing to identify the request.

17. A machine readable storage device having instructions for execution by a processor of a machine to cause the processor to perform operations comprising:

accessing, via a response bot, an electronic communication addressed to a user, wherein the electronic communication includes a request;
identifying, via the response bot, at least one or more of communications and documents to search based on the electronic communication request;
obtaining search results from the identified communications or documents matching the request;
; and
automatically sending a response to the request, the response including a calculated confidence level for the response.

18. The machine readable storage device of example 17 wherein the response includes an indication that the response was generated by the response bot.

19. The machine readable storage device of any of examples 17-18 wherein the response is generated as a function of a knowledge bank of previous communications and wherein the response bot updates the knowledge bank with the generated response.

20. The machine readable storage device of any of examples 17-19 wherein identifying communications and documents to search comprises parsing the electronic communication using natural language processing to identify the request and wherein the confidence level is generated as a function of a ranking of the search results.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
accessing, via a response bot, an electronic communication addressed to a user, wherein the electronic communication includes a request;
identifying via the response bot, at least one of communications or documents to search based on the request; and
obtaining search results from the identified communications or documents matching the request; and
automatically sending a response to the request, the response including a calculated confidence level for the response.

2. The method of claim 1 wherein the response is generated by the response bot based on the search results.

3. The method of claim 2 wherein the response includes an indication that the response was generated by the response bot.

4. The method of claim 1 wherein the response is generated by the response bot as a function of a knowledge bank of previous communications.

5. The method of claim 4 wherein the response bot updates the knowledge bank with the generated response.

6. The method of claim 1 wherein the confidence level is generated by the response bot.

7. The method of claim 6 wherein the confidence level is generated as a function of an artificial intelligence algorithm analysis of the search results.

8. The method of claim 1 wherein identifying communications and documents to search comprises parsing the electronic communication using natural language processing to identify the request.

9. The method of claim 8 wherein searching is performed via the response bot to obtain search results matching the request as a function of the parsed electronic communication.

10. A device comprising:
a processor; and
a memory device coupled to the processor and having a program stored thereon for execution by the processor to cause the processor to perform operations comprising:
accessing, via a response bot, an electronic communication addressed to a user, wherein the electronic communication includes a request;
identifying, via the response bot, at least one of communications or documents to search based on the request;
obtaining search results from the identified communications or documents matching the request; and
automatically sending a response to the request, the response including a calculated confidence level for the response.

11. The device of claim 10 wherein the response includes an indication that the response was generated by the response bot.

12. The device of claim 10 wherein the response is generated as a function of a knowledge bank of previous communications.

13. The device of claim 12 wherein the response bot updates the knowledge bank with the generated response.

14. The device of claim 12 wherein the confidence level is generated as a function of a ranking of the search results.

15. The device of claim 12 wherein the confidence level is generated as a function of an artificial intelligence algorithm analysis of the search results.

16. The device of claim 12 wherein identifying communications and documents to search comprises parsing the electronic communication using natural language processing to identify the request.

17. A machine readable storage device having instructions for execution by a processor of a machine to cause the processor to perform operations comprising:
accessing, via a response bot, an electronic communication addressed to a user, wherein the electronic communication includes a request;
identifying, via the response bot, at least one of communications or documents to search based on the electronic communication request;
obtaining search results from the identified communications or documents matching the request; and
automatically sending a response to the request, the response including a calculated confidence level for the response.

18. The machine readable storage device of claim 17 wherein the response includes an indication that the response was generated by the response bot.

19. The machine readable storage device of claim 17 wherein the response is generated as a function of a knowledge bank of previous communications and wherein the response bot updates the knowledge bank with the generated response.

20. The machine readable storage device of claim 17 wherein identifying communications and documents to search comprises parsing the electronic communication using natural language processing to identify the request and wherein the confidence level is generated as a function of a ranking of the search results.
